(19) United States
(12) Patent Application Publication
(10) Pub. No.: US 2024/0163220 A1
(43) Pub. Date: May 16, 2024

(54) METHODS AND APPARATUS FOR IMPROVED CONGESTION SIGNALING

(71) Applicant: HUAWEI TECHNOLOGIES CO., LTD., SHENZHEN (CN)

(72) Inventors: Ali MUNIR, Kitchener (CA); Shiva KETABI, Toronto (CA); Mahmoud Mohamed BAHNASY, Waterloo (CA); Sepehr ABBASI ZADEH, Toronto (CA); Yashar GANJALI, North York (CA)

(73) Assignee: HUAWEI TECHNOLOGIES CO., LTD., SHENZHEN (CN)

(21) Appl. No.: 17/984,381

(22) Filed: Nov. 10, 2022

(51) Int. Cl. H04L 47/31

(52) U.S. Cl. CPC H04L 47/31

(57) ABSTRACT

The present disclosure provides methods and apparatus for improved congestion signaling. According to an aspect, a method is provided. The method includes receiving, by a switch, at a first ingress port, a first packet originated at a source. The method may further include sending, by the switch via a first egress port, the first packet toward a destination. The method may further include receiving, by the switch, at a second ingress port, a second packet destined for the source. The method may further include marking, by the switch, the second packet based on congestion information of the first egress port. The method may further include sending, by the switch via a second egress port, the second packet toward the source.

### CROSS-REFERENCE TO RELATED APPLICATIONS

This is the first application filed for the present invention.

### FIELD OF THE INVENTION

The present invention pertains to the field of communication networks, and in particular to methods and apparatus for improved congestion signaling.

### BACKGROUND

The performance of a congestion control algorithm partly depends on the congestion signal received from the network. An important factor for a congestion signal may be the age of information in the signal. With traditional congestion control mechanisms, this information may be at least one round trip time (RTT) old (such as ECN or packet drops) or incur overheads (such as QCN at the switch or extra packets in the network) for fast congestion signaling. This delayed and old feedback of congestion information may be harming for the long haul networks that have long propagation delays. As a result, performance of congestion control algorithms may suffer in such networks.

Therefore, there is a need for methods and apparatus for improved congestion signaling that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides methods and apparatus for improved congestion signaling. According to a first aspect, a method is provided. The method includes receiving, by a switch, at a first ingress port, a first packet originated at a source. The method may further include sending, by the switch via a first egress port, the first packet toward a destination. The method may further include receiving, by the switch, at a second ingress port, a second packet destined for the source. The method may further include marking, by the switch, the second packet based on congestion information of the first egress port. The method may further include sending, by the switch via a second egress port, the second packet toward the source. The method may further include storing, by the switch, in a register, the congestion information of the first egress port. The method may provide for improved congestion feedback. The method may have low implementation overhead, as the method may be implemented in commodity switches with small footprint.

The register may have a size, in bits, at least equal to a number of egress ports in the switch, wherein at least one bit of the register corresponds to each egress port of the switch.

Storing, by the switch in a register, the congestion information of the first egress port may include setting a value to a first bit of the register, the first bit corresponding to the first egress port, the value of the bit indicating the congestion information.

The method may further include determining, by the switch, the first bit corresponding to the first egress port.

Marking, by the switch, the second packet based on the congestion information of the first egress port may include marking, by the switch, a header of the second packet based on the value of the first bit.

Determining, by the switch, the first bit corresponding to the first egress port may include performing a reverse hash function of the switch to determine the first egress port.

Marking, by the switch, the second packet based the congestion information of the first egress port may include marking, by the switch at one of: the second ingress port and the second egress port, a header of the second packet.

Marking, by the switch at one of: the second ingress port and the second egress port, a header of the second packet may include marking according to one of: explicit congestion notification (ECN), In-band Network Telemetry (INT), and eXplicit Congestion Control Protocol (XCP). The method may improve existing congestion control mechanisms. The method may further provide for improved throughput for DCI flows and reduced latency for DCN flows. The method may improve response time for solving DCN level congestion.

Congestion information may indicate one or more of: a queue state, a queue length, a load, a utilization, an available link capacity, that a queue size of the first egress port is greater than a threshold.

The first packet may be a first data packet. The second packet is one of: a second data packet and an acknowledgement packet.

According to another aspect, an apparatus is provided. The apparatus includes modules configured to perform one or more of the methods described herein.

According to another aspect, another apparatus is provided, where the apparatus includes: a memory, configured to store a program; a processor, configured to execute the program stored in the memory, and when the program stored in the memory is executed, the processor is configured to perform one or more of the methods described herein.

According to another aspect, a computer readable medium is provided, where the computer readable medium stores program code executed by a device, and the program code is used to perform one or more of the methods described herein.

According to another aspect, a chip is provided, where the chip includes a processor and a data interface, and the processor reads, by using the data interface, an instruction stored in a memory, to perform one or more of the methods described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an example of congestion feedback.

FIG. 2 illustrates congestion feedback delay in a network.

FIG. 3 illustrates utilization as a function of RTT for DCI traffic.

FIG. 4 illustrates packet marking scheme, according to an aspect.

FIG. 5 illustrates a sample register at a switch for storing queue state information of egress queues, according to an aspect.

FIG. 6 illustrates a diagram of packet marking based on a hash function, according to an aspect.

FIG. 7 illustrates information sharing between egress and ingress pipes, according to an aspect.

FIG. 8 illustrates a method, according to an aspect.

FIG. 9 illustrates an apparatus that may perform any or all of operations of the methods and features explicitly or implicitly described herein, according to an aspect.

It will be noted that throughout the appended drawings, like features are identified by like reference numerals.

### DETAILED DESCRIPTION

Aspects of the disclosure provides for methods and apparatus for improved congestion signaling or feedback. According to an aspect a method is provided that may improve congestion feedback. The method may be performed at a switch or by a switch. The method may include, receiving, by the switch, at a first ingress port, a first packet. The first packet may be a data packet that is sent or originated from a source. The method may further include sending, by the switch via a first egress port, the first packet toward a destination. The method may further include receiving, by the switch, at a second ingress port, a second packet. The second packet may be another data packet or an acknowledge packet. The second packet may be destined for the source. The method may further include sending, via a second egress port, the second packet toward the source. The method may further include, marking, by the switch, the second data packet. The marking may be based on congestion information of the first egress port. The method may further include sending, by the switch, the second data packet toward the source.

In some aspects, the method may further include, storing, by the switch, in a register, the congestion information of the first egress port. In some aspects, marking the second data packet comprises marking, at one of: the second ingress port and the second egress port, a header of the second packet. In some aspects, the congestion information may indicate one or more of: a queue state, a queue length, a load, a utilization, an available link capacity, that a queue size of the first egress port is greater than a threshold.

As mentioned previously, performance of a congestion control algorithm may partly depend on the congestion signal received from the network. Traditionally, many different congestion signals such as Explicit Congestion Notification (ECN), INT etc., have been proposed. However, traditional congestion control mechanisms may perform poorly in long haul networks due to slow congestion feedback.

An important factor for a congestion signal may be the age of the information in the signal (e.g., how old is the information in the signal). With traditional congestion control mechanisms, this information may be at least one round trip time (RTT) old (such as ECN) or may incur overheads (such as Quantized Congestion Notification (QCN) at the switch or extra packets in the network) for fast congestion signaling. This delayed and old feedback of congestion information may be damaging for the long haul networks that have long propagation delays. As a result, the performance of congestion control algorithms may suffer in such networks.

Aspects of the disclosure may provide for an enhanced switch (or a switch feature) that improves congestion signaling mechanism, for example, ECN capable congestion control algorithms.

Some aspects of the disclosure may apply to ECN based congestion control algorithms. Some aspect may provide for an enhanced mechanism to mark ECN field, in the packet headers, based on the queue states in the switches.

In some aspects, congestion feedback may be performed by marking packet headers based on an egress queue size. In the context of ECN, a packet header may comprise two ECN fields for marking. In case of congestion, the one or more ECN field in the packet header may be marked based on the egress queue size.

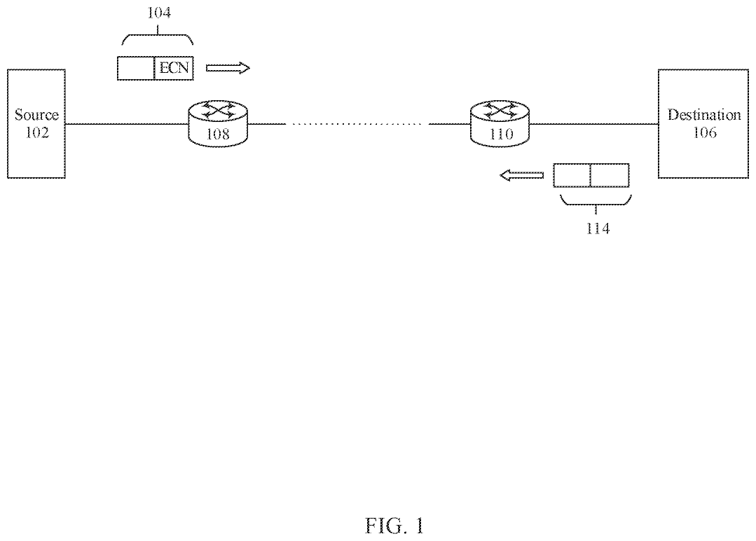

FIG. 1 illustrates congestion feedback between a source and a destination. A source 102 may send a packet 104 to the destination 106, a receiver, as illustrated. The packet 104 may have a header of different types, as may be appreciated by a person skilled in the art. For example, the packet 104 may have an an internet protocol (IP) header which has an ECN field. The ECN filed may be set to either ‘10’ or ‘01’ to announce that the congestion control at the host supports ECN marking. As the packet 104 moves along the path toward the destination 106, the ECN field in the header may be marked based on the state of the queue, at one or more switches (e.g., 108, 110) along the path. For example, if the size of outgoing queue (egress que size) at switch 108 is larger than a certain value or a threshold, then the ECN field of the packet header may be set to ‘11’. The same marking operations may be performed for each switch that meets the threshold criteria along the path. The markings (in the case of ECN, ECN marking) may indicate congestion information along the path at the one or more switches along the path.

When the packet 104 arrives at destination 106, the receiver may copy the congestion information indicated by the header marking into a header of an acknowledgement (ACK) packet 114. The acknowledgement packet 114 may then carry the congestion information back to the source 102, e.g., congestion feedback. Once the source 102 receives the information, the source may take appropriate actions, e.g., change condition window size, change the sending rate, etc.

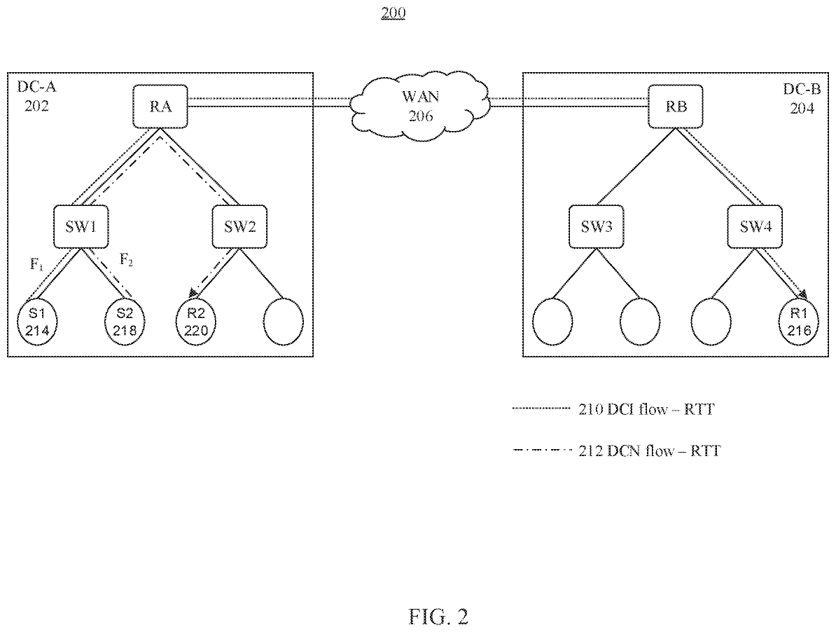

Traditional way of ECN mechanism may have disadvantages for long haul networks because the ECN information (referring to the congestion information) first travels to the destination and then back to the source. Thus, long delays may ensue due to one or more of queueing and link latency. Some challenges of the traditional ECN mechanism are described in reference to FIG. 2.

FIG. 2 illustrates congestion feedback delay in a network. The network 200 may be a long haul network. The network 200 may comprise two datacenters (DB) DC-A 202 and DC-B 204 connected via a wide area network (WAN) 206. Traffic between the two datacenters may be represented as data center interconnect (DCI) traffic 210, i.e., flow 1 (F1), and the traffic within a datacenter may be represented as data center network (DCN) traffic 212, i.e., flow 2 (F2). DCI traffic flow 210 may refer to a traffic, for example, from source S1 214 in DC-A 202 to destination R1 216 in DC-B 204, the traffic having a path comprising S1, switch 1 (SW1), router A (RA), WAN 206, router B (RB), SW 4, and R1. RA may be the left-side edge router, and RB may be the right-side edge router as illustrated. DCN traffic flow may refer to a traffic, for example, from source S2 218 in DC-A 202 to destination R2 220 also in DC-A 202, the traffic having a path comprising, S2, SW1, RA, SW2 and R2 as illustrated.

A first and major issue with traditional ECN mechanisms may be the age of information—delayed congestion feedback. With ECN, the congestion feedback for DCI traffic 210 may be substantially slower than that of DCN traffic. For example, DCI traffic 210 may have a 20 millisecond (ms) RTT, while DCN traffic 212 may have a 20 microsecond (μs) RTT. Thus, congestion feedback for DCI traffic may be ˜1000× slower than congestion feedback for DCN traffic 212.

Accordingly, DCI traffic 210 may not timely detect the congestion in DC-A 202 (local congestion) as the congestion feedback from the destination R1 may be very late (— RTT=20 ms). As a result, ECN based congestion control algorithm may have a strong interference between DCN and DCI traffic due to their reaction at different time scales.

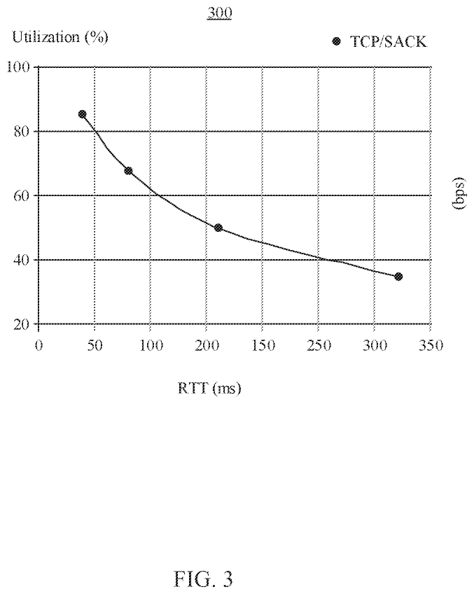

Further, DCI traffic may have a decreasing utilization as RTT increases, as illustrated in FIG. 3. FIG. 3 illustrates utilization as a function of RTT for DCI traffic. Utilization may refer to a ratio based on the actual transmission rate divided by max link capacity. The graph 300 is based on transmission control protocol (TCP) selective acknowledgement SACK. As illustrated, utilization for DCI traffic decreases as RTT increases. The decrease in utilization is partly due to slow ACK feedback.

According to an aspect, an enhanced switch may be provided for improved congestion feedback (signaling or management). The enhanced switch may comprise a switch feature based on inverse queue state sharing (iQS) at the switch. Some aspects of the disclosure (e.g., congestion management according to one or more aspects) may improve throughput for DCI flows (e.g., high throughput) and improve latency for DCN flows (e.g., low latency). Some aspects of the disclosure may apply to congestion control mechanisms that use ECN, for example but not limited to, TCP congestion control mechanisms and RDMA. Data Center Transmission Control Protocol (DCTCP) and Data Center Quantized Congestion Notification (DCQCN) are further examples of congestion control mechanisms (DCQCN being an RDMA protocol) that may be applicable according to one or more aspects. Some aspects of the disclosure may apply to long haul DCI networks such as network 200.

According to some aspects, the enhanced switch, based on iQS mechanism, may be used for one or more of DCI flows and DCN flows. A flow may be identified as a DCI flow or a DCN flow based on the source and destination IPs indicated by an associated packet. Thus, a packet may be classified as belonging to a DCI flow or a DCN flow based on the packet's source and destination IPs.

One or more aspects of the disclosure may be used inside DCNs. For example, congestion information within a DCN may be fed back according to one or more aspects herein, and appropriate actions may be taken based on congestion feedback.

Some aspects of the disclosure may be implemented in commodity switches having small footprint. In some aspects, the enhanced switch may be used with RDMA and Ethernet networks. According to some aspects, iQS mechanism may be implemented using ECN markings on the ACK packets. In some aspects, the ACK packets may be fed back based on a defined rate. In some aspects, iQS mechanism may be based on an egress port. In some aspects, the order in which ACK packets may be marked may vary. In some aspects, consecutive ACK packets may not be marked. In some aspects, consecutive packets may be marked.

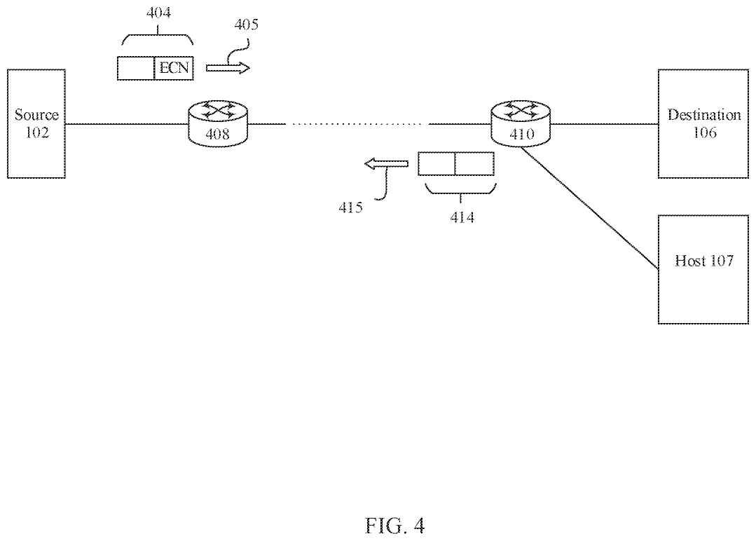

In some aspects, iQS mechanism may be carried out, in part, by marking packets based on congestion information in the opposite direction (e.g., at an egress port of a switch) as further described in reference to FIG. 4 and other aspects of the disclosure. In some aspects, congestion information may indicate one or more of: a queue state, a queue length, a load, a utilization, an available link capacity. In some aspects, congestion information may further indicate that a queue size of an egress port is greater than a threshold.

FIG. 4 illustrates a packet marking scheme, according to an aspect. In an aspect, when a first packet 404 (e.g., a data packet) is sent according to a first direction 405, e.g., from a source 102 to the switch 410, the packet 404 may remain unmarked (therefore not carry any congestion information) when received at the destination 106. Thus, the header (e.g., the ECN field in the case of ECN) of the first packet 404 sent to the destination 106 may remain unchanged. In some aspects, when second packet 414, e.g., an ACK packet or a data packet, is sent according to a second direction 415, e.g., from the switch 410 to the source 102. The second packet may be generated from the destination 106, a host 107 or another entity. The second packet 414 may be marked (e.g., ECN marking) based on congestion information (e.g., state of the egress queue) in the opposite or reverse direction. The opposite or reverse direction may refer to the first direction 405, from the source 102 to the switch 410. In some aspects, the congestion information may refer to a current state of the queue.

In some aspects, the direction 415 of the second packet need only be the opposite of the first direction 405 from the source 102 to the switch 410. Thus, the second packet need only to pass through switch 410 to the source 102.

In some aspects, the congestion information associated with a first direction 405, e.g., forward path congestion information, may be carried in opposite direction (e.g., direction 415) packets (e.g., indicated in a header of packet 414). Accordingly, congestion feedback based on iQS mechanism (e.g., marking of packets 414 moving in direction 415, the marking based on congestion information in direction 405) may reduce feedback delay.

In an aspect, the second packet 414 sent in the second direction 415 toward the source 102, may be marked at switch 410 based on congestion information (queue state) at the egress port of switch 410, the egress port determined based on packet 404 and the first direction 405. Similarly, second packet 414 may be marked at switch 408 based on congestion information (e.g., queue state) at the egress port of switch 408, the egress determined based on one or more of packet 404 and the first direction 405.

According to an aspect, the second packet need 414 moving in the second direction 415 can be sent from any entity (not limited to destination 106 and host 107), so long as the second packet passes through the switch 410 and is destined to the source 102.

In some aspects, the second packet 414, may, on its path to the source 102 in direction 415, pass through the same one or more switches that the packet 404 passed through on its path in direction 405. In some aspects, the path of packet 414 in direction 415 from switch 410 to source 102 may be symmetric to, but in reverse or opposite to, the path of packet 404 in direction 405 from source 102 to switch 410.

In some aspects, to ensure path symmetry (i.e., that the second packet 414 has the same path, in reverse, as that of the packet 404) the fields used to calculate the equal-cost multipath ECMP hash value at the backward path (referring to the path of packet 414) may be reversed. I.e., by swapping source and destination IP when calculating the hash function in the backward direction and swapping the source and destination ports too. Hence, the hash value becomes identical in backward path as the forward path (referring to the path of packet 404) as shown in FIG. 6.

To determine the state (or the current state) of queue in the first direction 405, in some aspects, various mechanisms, as may be known by a person skilled in the art, may be employed. In some aspects, a mechanism based on reverse hash (5-tuple) may be used to determine or select a corresponding egress queue.

In some aspects, the improvement to the congestion feedback (or the quality of congestion information fed back) may be based on the proximity of the congestion environment (e.g., switch 408 or 410) to the end-host (e.g., source). For example, the congestion information at switch 408 may be fresher (or more recent) than the congestion information at switch 410, since switch 408 is closer to source 102 than switch 410.

Accordingly, some aspects may provide for improved congestion feedback from local and remote nodes. Improvement in congestion feedback may be in terms of freshness or recency, which may further indicate improved reliability of the congestion information that is fed back. Accordingly, some aspects may obviate the need for maintaining flow state at one or more switches.

In some aspects, marking a header of a packet (e.g., packet 414) based on the egress queue in the reverse direction may involve sharing of queue state inside a switch.

In some aspects, a packet in one ingress or egress queue may need to access the state of another egress queue. For this purpose, the enhanced switch (based on iQS mechanism) may use or implement a register for storing queue state information of one or more egress queues. In some aspects, the enhanced switch may only need to know if the queue size is greater than a threshold, and therefore, obviate the need to maintain the actual queue size information for each egress queue.

In some aspects, a register (which may be referred to as an iQS register) having a size (e.g., in bits) at least equal to the number of egress ports in the switch may be used for storing que state information of the egress queues. According to an aspect, at least one bit of the register may correspond to each egress port of a switch. According to an aspect, for each port inside the switch, the corresponding register bit may indicate whether the queue size is greater than a threshold. For example, the corresponding register bit may be set to ‘1’ to indicate that the queue size of the corresponding egress port is greater than a threshold (i.e., congestion exists). Similarly, the corresponding register bit may be set to ‘0’ to indicate that the queue size of the corresponding egress port is less than the threshold (i.e., no congestion).

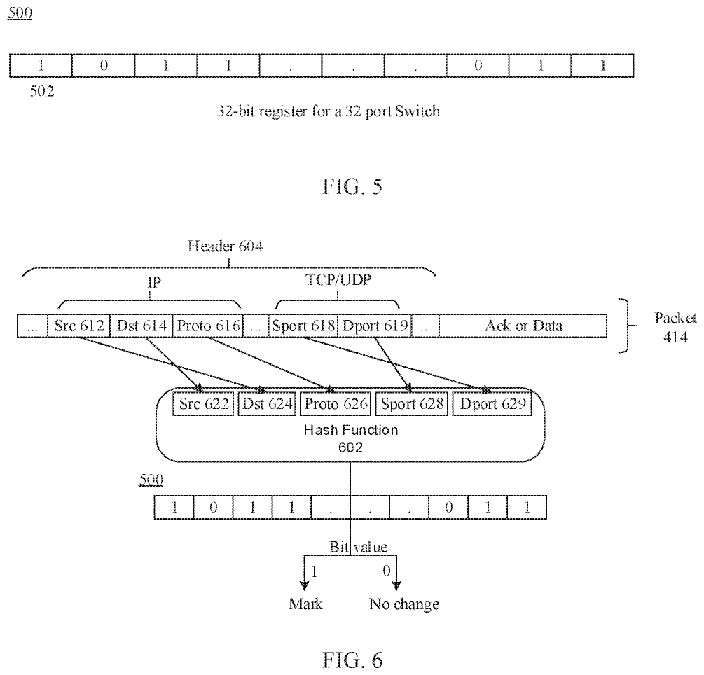

FIG. 5 illustrates a sample register at a switch for storing queue state information of egress queues, according to an aspect. In an aspect, the register 500 may be have a size of at least 32-bit register, where different bit of the register may correspond to an egress port in a 32-port switch. For each egress port that the queue size is greater than a threshold, the corresponding bit of the register 500 may be set to 1. For example, a first bit 502 of register 500 may correspond to a first egress port of a switch 408 or 410. Provided that the queue at the first egress port is greater than a threshold, the corresponding first bit 502 may then be set to 1 indicating that the first egress port may be congested (i.e., having a queue size greater than a threshold). In an aspect, the register 500 or the bit values therein may be shared with or available to one or more ingress ports of the switch.

According to some aspects, a switch may receive at a first ingress port a first packet 404. The switch may send the first packet 404 toward its destination 106 via a first egress port. The switch may then receive, at a second ingress port, a second packet 414 bound for or directed to the source 102. In some aspects, the switch may determine the first egress port and the corresponding bit register. Based on the indication of the corresponding bit register (in the iQS register), the switch may mark the second packet. For example, if the corresponding bit register for the first egress port (used to send the first packet 404 toward destination 106) indicates a congestion information then the switch may mark a header of the second packet 414 to indicate the congestion information. The congestion information may indicate one or more of a queue state, a queue length, a load, a utilization, an available link capacity, that a queue size of the first egress port is greater than a threshold. Based on the congestion information, the switch may mark a bit of the header of the second packet to indicate the congestion information. In some aspects, the marking may be based on one of: ECN marking, INT marking, and XCP marking.

In some aspects, marking of the second packet 414 may be based on state of the egress queue (referring to the first egress port). In some aspects, marking of the second packet 414 may comprise determining the bit register corresponding with the first egress port.

In some aspects, the first packet 404 (going in the first direction 405) and the second packet 414 (going in the second direction 415) may pass through different ports of switches 408 and 410. In such aspects, switch 408 (or 410) receiving the second packet 414 may need to determine the egress port (e.g., the first egress port) at switch 408 (or 410) corresponding to the first packet 404 in the first direction 405. In some aspects, determining the first egress port at a switch corresponding to the first packet 404 in the first direction 405 may include determining the corresponding bit in the iQS register.

According to an aspect, determining the first egress port at a switch corresponding to the first packet 404 in a first direction 405 (or determining the bit in the iQS register corresponding to the egress port at the switch) may be based on the hashing functionality of the switch (e.g., based on the 5-tuples of sourceIP, DestinationIP, protocol (or next header for IPv6), sourcePort, destinationPort). In some aspects, the switch may be based on ECMP hashing, for example.

In some aspects, determining the first egress port and the corresponding bit of the iQS register may include performing a reverse hash function at the switch (e.g., swapping the 4-tupple values), as may be appreciated by a person skilled in the art.

FIG. 6 illustrates a diagram of packet marking based on the inverse hash function and the congestion state specified by iQS register, according to an aspect. As may be appreciated by a person skilled in the art, determining, at a switch 408 or 410, the first egress port to direct the first packet 404 toward destination, in the first direction, may be based on a hash function. For example, the first egress port may be determined based on one or more of: a source port, a destination port, a source IP, a destination IP, and the protocol (next header for IPv6), as may be indicated in the packet header.

In an aspect, the second packet 414 may comprise a header 604. The header may comprise one or more fields indicating: a source (Src) IP 612, a destination (Dst) IP 614, a protocol (Proto) number 616 (next header in IPv6), a source port (Sport) 618 at TCP or UDP header, and a destination port (dport) 619 at TCP or UDP header. To determine the first egress port corresponding to the first packet 404, a reverse hash function may be performed.

In some aspects, a second packet 414 moving in the second direction 415 may be received at the switch, e.g., at an ingress port of the switch. In some aspects, a reverse hash function 602 may be performed to determine the first egress port (corresponding to the first packet 404). In an aspect, hash function 602 may comprise one or more fields for: source IP 622, destination IP 624, Protocol number 626, source port 628, and a destination port 629. To apply the reverse hash function, in an aspect, the source IP field and the destination IP field indicated in the packet header 604 may be swapped in the hash function fields as illustrated. For example, the source IP field 622 may be set to the destination IP 614, and the destination IP field 624 may be set to the source IP 612. Similarly, the source port and the destination port indicated in the packet header 604 may be swapped in the hash function fields as illustrated. For example, the source port field 628 may be set to the destination port 619 and the destination port field 629 may be set to the source port 618 as illustrated. The protocol field 616 may be set to the protocol 616. Based on the determined first egress port, the bit corresponding to the first egress port may thus be determined.

Accordingly, the reverse hash function 602 may determine which bit of the register 500 corresponds with the first egress port of the switch that directed the first packet 404 in the first direction toward the destination.

Depending on the value of the corresponding bit, the second packet 414 may be marked accordingly. For example, the corresponding bit may have a value indicating congestion information (e.g., congestion), then the header of packet 414 may be marked to indicate the congestion information. For example, the corresponding bit may have a value of ‘1’ which indicates congestion at the first egress port. Accordingly, the switch may mark the header of the second packet 414, by setting the header bit value to ‘1’, to indicate congestion at the first egress port of the switch.

Similarly, if the value of the corresponding bit indicated no congestion at the first egress port, then, in an aspect, the switch may not mark the second packet (e.g., change ECN field) to ‘0’, thereby indicating no congestion at the first egress port (e.g., egress queue is less than the threshold).

In some aspects, depending on the switch, different mechanisms may be used to determine which egress port (e.g., the first egress port), in the first direction 405, was used to send the first packet 404. Accordingly, appropriate mechanism, depending on the switch, may be used to determine which corresponding bit in register 500 may be read for marking the second packet 414.

In some aspects, the end-host which receives the second packet 414 may need to adapt its congestion window or transmission rate. As described herein, different from traditional ECN marking, in some aspects, ECN marking may be performed only on the second packets 414, e.g., ACK packets or data packets, in the second direction 415.

In some aspects, at source 102, the congestion information (e.g., ECN information) received from the second packet 414 may be used to control the congestion window size or rate of the outgoing traffic.

According to some aspects, iQS mechanism may be used for various application of information feedback. For example, in some aspects, iQS mechanism may be used for congestion feedback in the context of ECN. In some aspects, iQS mechanism may be used for information feedback in the context of INT, e.g., queue utilization feedback. In some aspects, iQS mechanism may be used for information feedback in the context of XCP, e.g., available link capacity. Accordingly, any congestion information may be fed back according to one or more aspects described herein. For example, one or more congestion information (e.g., load, utilization, available link capacity) associated with an egress port may be fed back. In an aspect, a threshold may be defined for a congestion information (e.g., load, utilization, available link capacity) to be fed back. According to the defined threshold a corresponding bit (corresponding to an egress port) may be set to 1 or 0, to indicate that a threshold (with respect to a congestion information) is met or not met.

In some aspects, one signal may be conveyed at a time, thus one type of congestion information may be fed back using ECN marking. In some aspects, different type of congestion information may be fed back one signal (feedback) after another. In some aspects, a plurality of registers may exist, where each register may correspond to a different congestion information. In some aspects, one register may be used, and the one register may be configured to store different congestion information associated with the egress ports.

Accordingly, different congestion information may be fed back by different signals. For example, a first feedback signal (e.g., a first returning packet) may indicate a first type of congestion information (e.g., queue state); then a second feedback signal (e.g., a second returning packet, which may, but need not, be subsequent to the first returning packet) may indicate a second type of congestion information (e.g., a load, a utilization, an available link capacity) associated with the egress ports.

In some aspects, the order of what congestion information may be fed back may be customized. In some aspects, the rate at which a certain congestion information may be fed back may be customized. Any combination of order of congestion information and rate of feedback may be determined, as may be appreciated by person skilled in the art.

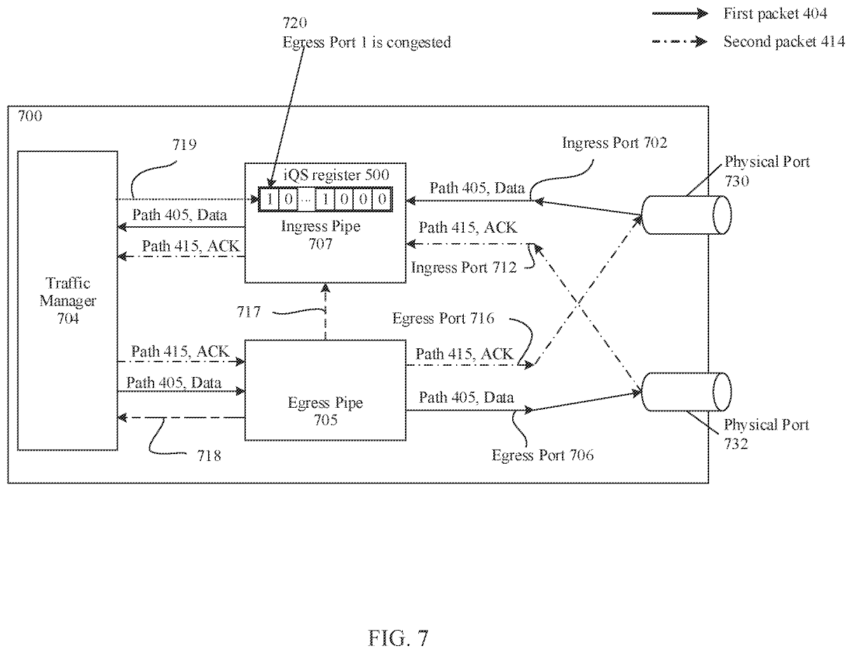

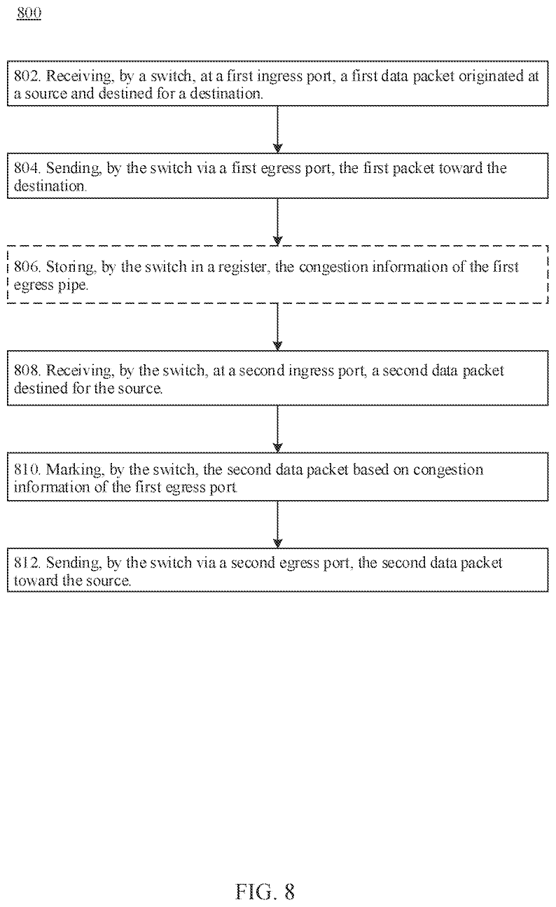

FIG. 7 illustrates information sharing between egress and ingress pipes, according to an aspect. Switch 700, which may be similar to switch 408 or 410, may comprise one or more physical ports 730 and 732. Each physical port may comprise one ingress pipe or port, which deals with incoming packets, and one egress pipe or port which deals with outgoing packet.

In an aspect, a first packet 404 may be received, by switch 700, at a first ingress port 702. In some aspects, the first packet may be a data packet sent or originated from a source (e.g., 102). In some aspects, the switch may comprise a traffic manager 704 which stores congestion information about queue states of the egress ports. In some aspects, switch 700 (via the traffic manager 704), may determine a first egress port 706 for routing the first packet toward a destination. In some aspects, the traffic manager 704 may determine the first egress port 706 based on information indicating one or more of: a source port, a destination port, a source IP, a destination IP, and a protocol. In some aspects, the first egress port 706 and the first ingress port 702 may belong to a same or different physical port. In the illustrated example, the first ingress port 702 belongs to a first physical port 730, and the first egress port 706 belongs to a second physical port 732. In some aspects, the first ingress port 702 and the second egress port 716 may belong to a same physical port. Similarly, in some aspects, the first egress port 706 and the second ingress port 712 may belong to a same physical port.

Upon determining the first egress port 706, the switch or via the traffic manager as the case may be, may route or send the first packet using the first egress port 706 toward the destination. Accordingly, the first packet 404 may have path 405 as illustrated. Path 405 may include first ingress port 702 (of physical port 730), traffic manager 704, and egress port 706 (of physical port 732).

In some aspects, the first packet 404 or the traffic manager 704 may update the iQS register with the congestion information (e.g., queue length, load, utilization, available link capacity) associated with the first egress port 706. For example, packet 404 may generate a recirculation packet that may be sent 718 back to TM 704, then sent 719 to ingress pipe 707 to update iQS register 500 with congestion information (e.g., queue length state). The congestion information may be stored in a register (e.g., iQS register 500).

According to an aspect, when the first packet passes through the first egress port 706, congestion information at the first egress port may be shared with the one or more of: ingress pipes 702 and 712 and egress pipes 716. In an aspect, the first packet may be cloned, congestion information (associated with the first egress port 706) added to the packet and recirculated 718. According to the congestion information at the first egress port 706, the traffic manager 704 may update or write to the iQS register. In an aspect, the congestion information may indicate that a threshold is met (e.g., a queue size is greater than a threshold indicating congestion), and according to this information the bit 720 corresponding to the first egress port 706 may be set to a value, e.g., ‘1’, to indicate congestion.

The traffic manager 704 may have access to the congestion information, via recirculation 718, from the egress ports. In some aspects, the congestion information of the first egress port may be shared 717, with the first ingress port 702 and the second ingress port 712 to update the iQS register 500. The sharing 717 of congestion information is a logical process which may take place by passing such information through the traffic manager 704, as described in reference to recirculating 718 and 719 and to update the iQS register 500. In some aspect, the sharing 717 of congestion information may take place by generating a new packet at the Egress Pipe 705 and adding the congestion information to the payload, and recirculating the new packet through the traffic manager 704.

Accordingly, in some other aspect, when the first packet encounter congestion at the first egress port, the switch (via the egress pipe 705) can clone the packet and trim the payload and recirculate it after adding the congestion information.

In some aspects, a second packet 414 may be received, by switch 700, at a second ingress port 712. The second packet may be an ACK packet or a data packet sent destined to the source (e.g., 102).

In some aspects, when receiving the second packet 414 at the second ingress port 712, the second packet 414 may be marked based on congestion information of the first egress port 706, since the second packet 414 may correspond with the first packet 404. The second packet 414 may correspond with the first packet 404 based on their path symmetry. The second ingress port 712 may know of the congestion information of the egress ports from the iQS register 500, but may not know which egress port the first packet 404 used. According to an aspect, a revers hash function may be performed, on the second packet 414, to determine the first egress port 706 used by the first packet 404, as described herein. Upon determining the first egress port 706, the corresponding bit 720 may be read to determine the congestion information at the first egress port 706.

Based on the congestion information corresponding to the first egress port 706, the switch, via or at the traffic manager 704, the second ingress port 712, or the second egress port 716, may mark a header of the second packet 414. In some aspects, the congestion information may indicate one or more of a queue state, a queue length, a load, a utilization, an available link capacity, that a queue size of the first egress port is greater than a threshold. In some aspects, the second packet may be marked (e.g., one or more header bits may be set to a value) to indicate the congestion information.

In some aspects, after marking the second packet 414, the second packet 414 may be sent to the traffic manager 704. Thereafter, the switch (via the traffic manager) may determine a second egress port 716 for routing the second packet toward the source. Accordingly, in an aspect, the second packet 414 may have path 415 as illustrated. Path 415 may include second ingress port 712 (of physical port 732), traffic manager 704, and egress port 716 (of physical port 730).

In some aspects, the marking of the second packet 414, based on congestion information at the first egress port 706, may be performed at the second egress port 716. After determining the second egress port 716, the packet 414 may be sent to the egress port 716 via path 415. The packet 415 may be marked, at the second egress port, according to the congestion information associated at the first egress port 706 stored in a corresponding bit of the register 500.

In some aspects, the marking of the second packet 414, based on congestion information at the first egress port 706, may be performed at any permitted point along the path 415 (e.g., at second ingress sport 712, TM 704, or second egress port 716), as may be appreciated by a person skilled in the art.

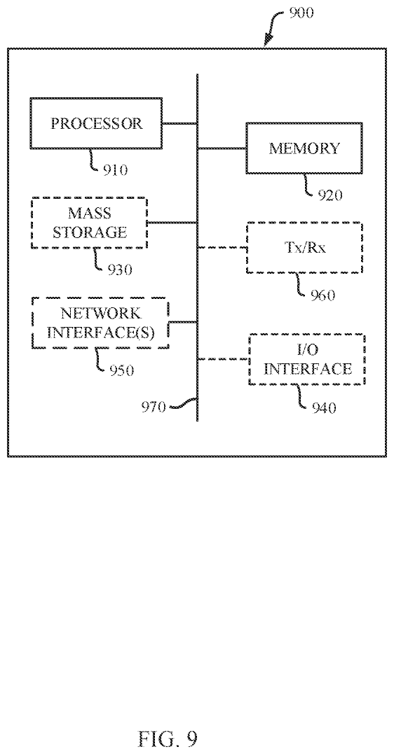

FIG. 8 illustrates a method, according to an aspect. The method 800 may comprise, at 802, receiving, by a switch, at a first ingress port, a first data packet originated at a source. The method 800 may further comprise, at 804, sending, by the switch via a first egress port, the first packet toward a destination. The method 800 may further comprise, at 806, storing, by the switch, in a register, the congestion information of the first egress pipe. In some aspects, the method 800 may further comprise, at 808 receiving, by the switch, at a second ingress port, a second data packet destined for the source. The method 800 may further comprise, at 808, marking, by the switch, the second data packet based on congestion information of the first egress port. The method 800 may further comprise, at 810, sending, by the switch via a second egress port, the second data packet toward the source.

In some aspects, the register may have a size, in bits, at least equal to a number of egress ports in the switch, wherein at least one bit of the register corresponds to each egress port of the switch. In some aspects, storing, by the switch, in a register, the congestion information of the first egress pipe may comprise setting a value to a first bit of the register, the first bit corresponding to the first egress port, the value of the first bit indicating the congestion information.

In some aspects, the method 800 may further comprise, determining, by the switch, the first bit corresponding to the first egress port. In some aspects, marking, by the switch, the second data packet based on a queue state of the first egress port may comprises marking, by the switch, at one of: the second ingress port and the second egress port, a header of the second packet based on the value of the first bit.

In some aspects, determining, by the switch, the first bit corresponding to the first egress port may comprise performing a reverse hash function of the switch to determine the first egress port. In some aspects, marking, by the switch, the second data packet based the congestion information of the first egress port may comprise marking, by the switch at one of: the second ingress port and the second egress port, a header of the second packet.

In some aspects, marking, by the switch at one of: the second ingress port and the second egress port, a header of the second packet is performed according to one of: explicit congestion notification (ECN), INT, and XCP. In some aspects, congestion information may indicate one or more of: a queue state, a queue length, a load, a utilization, an available link capacity, that a queue size of the first egress port is greater than a threshold.

According to one or more aspects described herein, improved congestion signals maybe provided. In some aspects, one or both of DCN and DCI flows may be enabled to react at improved timescales. According to some aspects, local DCN level congestion may be solved with reduced delay (e.g., 20 us, instead of waiting for whole RTT ˜20 ms).

One or more aspects may provide for reduced implementation overhead. Some aspects of the disclosure may be implemented in commodity switches with reduced footprint. Some aspects may obviate the need for flow state or congestion control information. Some aspects may be used with RDMA and Ethernet, as may be appreciated by a person skilled in the art.

Some aspects of the disclosure may apply to or used in one or more networks including, Wi-Fi, LTE, and 5G, among others, as may be appreciated by a person skilled in the art.

FIG. 9 is an apparatus that may perform any or all of operations of the above methods and features explicitly or implicitly described herein, according to an aspect. In some aspects, the apparatus 900 may refer to a data parallel architecture, a processing unit, a GPU, and the like as may be appreciated by a person skilled in the art. In some aspects, apparatus 900 may be used to implement one or more aspects described herein.

As shown, the apparatus 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. According to certain aspects, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 930 may include any type of non-transitory storage device, such as a solid state drive, hard disk drive, a magnetic disk drive, an optical disk drive, USB drive, or any computer program product configured to store data and machine executable program code. According to certain aspects, the memory 920 or mass storage 930 may have recorded thereon statements and instructions executable by the processor 910 for performing any of the aforementioned method operations described above.

One or more aspects of the disclosure may be implemented using electronics hardware, software, or a combination thereof. Some aspects may be implemented by one or multiple computer processors executing program instructions stored in memory. Some aspects may be implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions provided herein, some aspects may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods according to one or more aspects described herein. For example, such an execution may correspond to a simulation of the logical operations as described herein. The software product may additionally or alternatively include a number of instructions that enable a computer device to execute operations for configuring or programming a digital logic apparatus in accordance with one or more aspects described herein.

Although some aspects have been described with reference to specific features and embodiments, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, by a switch, at a first ingress port, a first packet originated at a source;
sending, by the switch via a first egress port, the first packet toward a destination;
receiving, by the switch, at a second ingress port, a second packet destined for the source;
marking, by the switch, the second packet based on congestion information of the first egress port; and
sending, by the switch via a second egress port, the second packet toward the source.

2. The method of claim 1 further comprising: storing, by the switch, in a register, the congestion information of the first egress port.

3. The method of claim 2, wherein the register has a size, in bits, at least equal to a number of egress ports in the switch, wherein at least one bit of the register corresponds to each egress port of the switch.

4. The method of claim 3 wherein storing, by the switch in a register, the congestion information of the first egress port comprises setting a value to a first bit of the register, the first bit corresponding to the first egress port, the value of the bit indicating the congestion information.

5. The method of claim 4 further comprising:
determining, by the switch, the first bit corresponding to the first egress port.

6. The method of claim 4, wherein marking, by the switch, the second packet based congestion information of the first egress port comprises:
marking, by the switch, a header of the second packet based on the value of the first bit.

7. The method of claim 6, wherein determining, by the switch, the first bit corresponding to the first egress port comprises: performing a reverse hash function of the switch to determine the first egress port.

8. The method of claim 1, wherein marking, by the switch, the second packet based the congestion information of the first egress port comprises:
marking, by the switch at one of: the second ingress port and the second egress port, a header of the second packet.

9. The method of claim 8 wherein marking, by the switch at one of: the second ingress port and the second egress port, a header of the second packet comprises marking according to one of:
explicit congestion notification (ECN), In-band network telemetry (INT), and eXplicit congestion control protocol (XCP).

10. The method of claim 1, wherein congestion information indicates one or more of: a queue state, a queue length, a load, a utilization, an available link capacity, that a queue size of the first egress port is greater than a threshold.

11. The method of claim 1 wherein:
the first packet is a first data packet; and
the second packet is one of: a second data packet and an acknowledgement packet.

12. An apparatus comprising:
at least one processor and at least one machine-readable medium storing executable instructions which when executed by the at least one processor configure a switch for:
receiving at a first ingress port, a first packet originated at a source;
sending, via a first egress port, the first packet toward a destination;
receiving at a second ingress port, a second packet destined for the source;
marking the second packet based on congestion information of the first egress port; and
sending, via a second egress port, the second packet toward the source.

13. The apparatus of claim 12, wherein the executable instructions which when executed by the at least one processor further configure a switch for:
storing, in a register, the congestion information of the first egress port.

14. The apparatus of claim 13 wherein the register has a size, in bits, at least equal to a number of egress ports in the switch, wherein at least one bit of the register corresponds to each egress port of the switch.

15. The apparatus of claim 14, wherein storing, in the register, the congestion information of the first egress port comprises setting a value to a first bit of the register, the first bit corresponding to the first egress port, the value of the bit indicating the congestion information.

16. The apparatus of claim 15, wherein marking the second packet based on a queue state of the first egress port comprises:
marking a header of the second packet based on the value of the first bit.

17. The apparatus of claim 12, wherein marking the second packet based the congestion information of the first egress port comprises:
marking, at one of: the second ingress port and the second egress port, a header of the second packet.

18. The apparatus of claim 17, wherein marking, at one of: the second ingress port and the second egress port, a header of the second packet comprises marking according to one of: explicit congestion notification (ECN), In-band network telemetry (INT), and eXplicit congestion control protocol (XCP).

19. The apparatus of claim 12, wherein congestion information indicates one or more of: a queue state, a queue length, a load, a utilization, an available link capacity, that a queue size of the first egress port is greater than a threshold.

20. The apparatus of claim 12, wherein
the first packet is a first data packet; and
the second packet is one of: a second data packet and an acknowledgement packet.
